(19) United States
(12) Patent Application Publication
(10) Pub. No.: US 2002/0010747 A1
(43) Pub. Date: Jan. 24, 2002

(54) Method for acquiring on-line information regarding customer preferences and a target advertising method using e-mail based on customer preferences

(75) Inventor: Jaehyuk-Hwang, Seoul (KR)

Correspondence Address: Paul J. Farrell, Esq., DILWORTH & BARRESE, LLP, 333 Earle Ovington Blvd., Uniondale, NY, 11553, US

(73) Assignee: ABLECLICK CORP.

(21) Appl. No.: 09/907,123

(22) Filed: Jul. 17, 2001

(30) Foreign Application Priority Data
Jul. 21, 2000 (KR) 10-2000-41793

(51) Int. Cl. G06F 15/16; G06F 15/173

(52) U.S. Cl. 709/206; 709/223; 709/224

(57) ABSTRACT

The present invention provides a method for acquiring information on-line on customer preferences. The method includes joining or registering with an Internet-based advertising agency as a member thereof, collecting a profile of said member, collecting a preference of the member on the basis of the collected profile of said member, collecting the advertising effect on each member on the basis of said collected preference, analyzing said collected profile, collected preference and collected advertising effect and preparing a report on the basis of the result of said analysis and presenting it an advertising client member. The present invention also provides an e-mail target advertising method based on the preference of each on-line customer, and includes selecting an advertising target on the basis of the profile and preference of each customer by an Internet-based advertising agency, providing a target advertisement to said selected target customer, analyzing the result of said target advertisement, and preparing a report on the target advertisement on the basis of the result of said analysis and then presenting it to an advertising client.

### BACKGROUND OF THE INVENTION

1. Field of the Invention

The present invention relates to a method for acquiring on-line information regarding customer preferences, and a target advertising method using e-mail based on customer preferences. More particularly, the present invention relates to a method for linking the conventional method for acquiring customer information on-line with conventional e-mail target advertising methods.

2. Description of Related Art

Generally, there are two methods for acquiring customer information, the off-line method and the on-line method. The method for acquiring customer information off-line acquires the customer information through a questionnaire or through mail, while the method for acquiring customer information on-line acquires the customer information generally through e-mail.

The e-mail target advertising method can be categorized into two kinds depending upon the manner used to select the advertising target:

first, there is a target advertising method based on a profile of the customer; and

second, there is a target advertising method based on customer preferences.

E-mail target advertisement based on the profile of the customer is a method which is already in the public domain, but conventional methods devised so far have not made e-mail target advertising method based on the preference of the customer available through the Internet. Generally, research into the preference of the customer has been carried out by media research agents, but such research has never been linked to on-line target advertisement.

The www.ezmoa.com web site is an example of the prior art to which the present invention is related. This web site gives a certain reserve fund such as cyber-money, per click to a member when the member logs onto the web site and sees an advertisement, and limits the number of clicks per advertisement to a certain number, as visitors to the web site increase and therefore, the number of visitors that may click on the advertisement will be increased by a geometric progression, which consequently imposes a considerable burden on the advertising client. Besides, even though the web site also provides a target advertisement, it does not use an e-mail target advertisement method based on the preference of the customer through Internet.

### SUMMARY OF THE INVENTION

The present invention has been devised to provide a solution to the above-described problem of the prior art. It is therefore an object of the present invention to provide a method for acquiring information on the preference of the customer on-line and providing an e-mail target advertising method based on the customer's preference, for each on-line customer.

Accordingly, the present invention provides a method for acquiring information on customer preferences on-line comprising the steps of registering a customer with an Internet-based advertising agency as a member thereof; collecting a profile of said member; collecting a preference of said member on the basis of the collected profile of said member; collecting an advertising effect on each member on the basis of said collected preference; analyzing at least one of said collected profile, collected preference and collected advertising effect; and preparing a report on the basis of the result of said analysis step and presenting said report to an advertising client member of the advertising agency.

The present invention further provides an e-mail target advertising method based on preferences of on-line customers comprising the steps of selecting an advertising target customer on the basis of a profile and preference of each customer of an Internet-based advertising agency; providing a target advertisement to said selected target customer; analyzing the result of said target advertisement; and preparing a report on the target advertisement on the basis of the result of said analysis and presenting the report to an advertising client.

### BRIEF DESCRIPTION OF THE DRAWINGS

The above object, other features and advantages of the present invention will become more apparent as described in the preferred embodiment set forth below, with reference to the accompanying drawings, in which:

FIG. 1 is a flow diagram showing a method for acquiring information on the preference of the customer on-line, according to the present invention.

FIG. 2 is a flow diagram showing a target advertising method using e-mail based on the preference of the customer, according to the present invention.

### DETAILED DESCRIPTION OF THE PREFERRED EMBODIMENTS

Before the present invention is described, it would be helpful to define significant terms as used in the present invention, as follows:

An Internet user means a netizen who has not joined Ableclick™, an Internet advertising agency, as a member thereof. A netizen associate member means a user who is registered automatically and implicitly through an e-mail input window on an advertisement inserted by said advertising agency (i.e., he or she is not yet a regular member who has agreed to join the advertising agency as a member thereof.). A netizen member means a person who has joined the advertising agency as a member thereof for the purpose to obtain earnings through clicks on the advertisement.

A host member means a person who owns his or her own web site and has joined the advertising agency as a member thereof for the purpose to gain earnings by placing advertisements on his or her web site.

An advertising client member means a person who owns his or her own web site and has joined the advertising agency as a member thereof for the purpose to protect his or her web site or products.

A host web site means a commercial web site or a non-commercial individual home page that a host member owns or has a right to edit.

An advertising server means a software system to execute an advertisement provided by an advertising client member through a host web site, including start, end, approval, log-in, statistics, analysis and settlement of the advertisement.

An e-mail questionnaire based on the profile of the customer means an e-mail questionnaire to be sent to a target customer selected on the basis of individual information inputted by each member when he or she joins the advertising agency as a member thereof through its web site, or through a function provided to change any individual information.

A target advertising e-mail based on the profile of the customer means an advertising e-mail to be sent to a target customer selected on the basis of individual information inputted by each member when he or she joins the advertising agency as a member thereof through its web site or through a function provided to change any individual information.

A target advertising e-mail based on the preference of the customer means an advertising e-mail to be sent to a target customer selected on the basis of individual preference information inputted by each member through the e-mail of the advertising agency for collecting information on a propensity to advertise.

An analysis of a propensity of netizens means a report as prepared on the basis of the answers of members of the advertising agency to a specific on-line questionnaire including questions on the characteristics of netizens and the propensity for netizens to purchase certain products as created by an advertising client or said advertising agency, and further by a function provided to prepare such a report.

Also, an analysis of an advertising effect on netizens means a report as prepared on the basis of the answers of members of the advertising agency to a specific on-line questionnaire created by an advertising client or the advertising agency, and further by a function provided to prepare such a report.

The e-mail target advertising method based on the preference of the customer, according to the present invention, comprises a method for linking conventional advertising target selection to a target advertisement, and also an improved method for noticeably shortening a target selection period.

This method is equipped with three important functions:

The first function is to send e-mails for determining a propensity of customers and further to collect the resulting answers from them.

The second function is to send e-mails for determining the advertising effect on customers and further to collect the resulting answers from them.

The third function is to execute an e-mail target advertisement using the resulting answers.

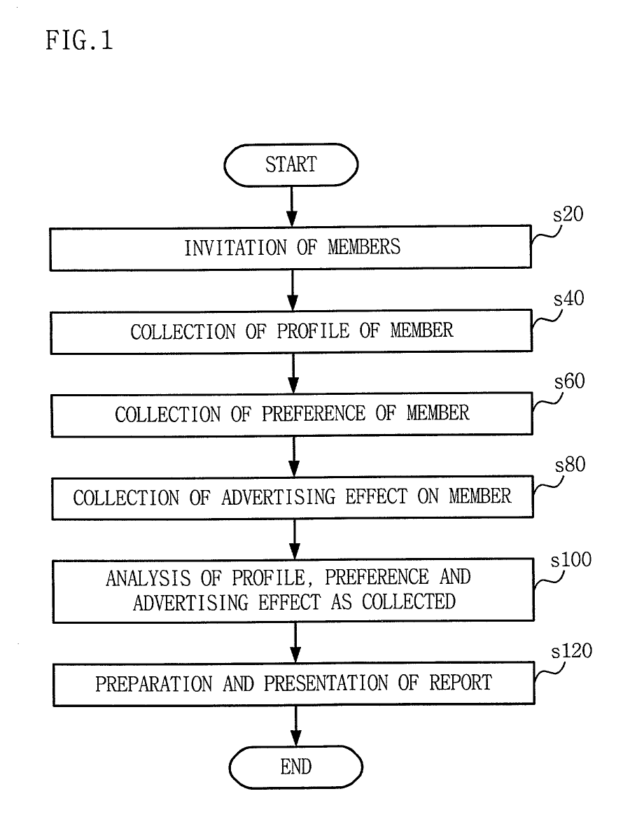

FIG. 1 is a flow diagram showing the method for acquiring information on-line on the preference of a customer, according to the present invention. As shown in the drawing, in the first place, an Internet user joins Ableclick™, an Internet advertising agency as a member thereof, at step s20. When the Internet user joins the Ableclick™ web site, he or she provides his or her e-mail address, password and basic personal information to Ableclick™.

Members are categorized into three kinds of members, a netizen member, a host member and an advertising client member. Anyone can join as a netizen member, a host member or an advertising client member upon completing the respective application procedures for membership.

Ableclick™ collects the profile of each member at step s40. Each member provides his or her basic profile as a member to Ableclick™. The basic profile of the member includes an e-mail address and a password, and other information to be required for paying a reserve fund and presenting a prize, such as awarded by drawing from a reserve fund, to the member and receiving an advertising fee, as essential items.

When a member is to modify or add some items to his or her profile after joining Ableclick™ as a member, he or she uses a function provided to change the member information as provided by the Ableclick™ web site.

Such changed information on the profile of the member is automatically reflected on the database through the related function of the web site.

The preference of the member is then collected at step s60. Ableclick™ sends the e-mail questionnaire based on the profile of the member to each member in order to collect preferences and the likes and dislikes of the member by industries, by products or by advertising clients.

The member participates in Ableclick™'s process of collecting preferences by filling in the question items of the e-mail questionnaire in HTML form and immediately answering it.

The answer of the member is automatically reflected on the preference database by the advertising server.

The advertising effect on the member is then collected at step s80. Ableclick™ sends the e-mail questionnaire based on the preference of the member to each member in order to collect the advertising effect on the member by industries, by products or by advertising clients.

The member participates in said Ableclick™'s process of collecting the advertising effect on the member by filling in the question items of the e-mail questionnaire in HTML form and immediately answering it.

The answers of the member are automatically reflected on the advertising effect database by the advertising server.

The profile, the preference and the advertising effect are then analyzed at step s100 by the advertising agency. On the basis of the answers from members, a profile analysis report, a preference analysis report and an advertising effect analysis report are respectively prepared by the applicable function of the web site.

The analysis report may include a table, a graph, a list, a technique, etc..

The respective table items of the analysis report are constituted of the percentage and the number of customers to be analyzed, and this information is used as basic data for the e-mail target advertisement. This is a core part of the present invention, through which research results are linked to the target advertisement.

A report is then presented at step s120. The on-line report prepared through the Ableclick™ web site is presented to the advertising client, and the advertising client can receive the report by logging onto the web site.

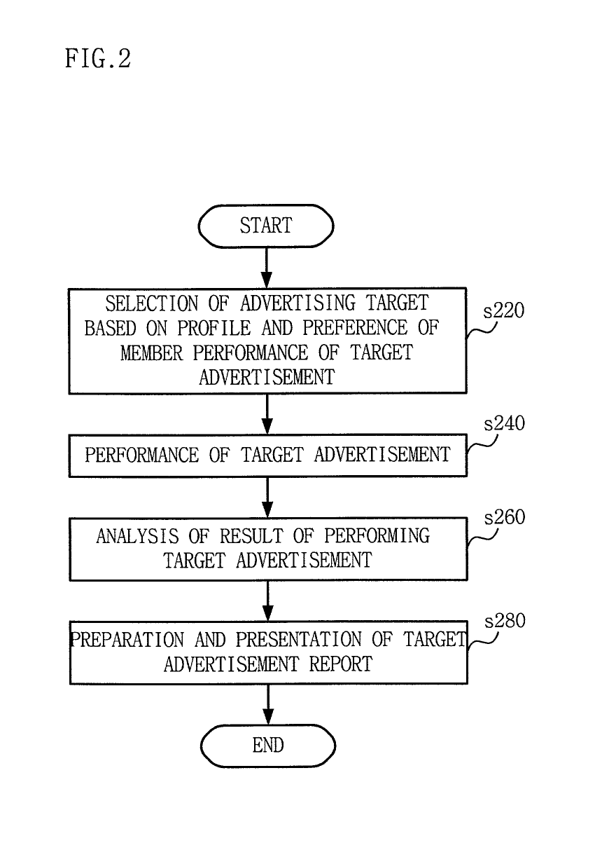

Meanwhile, FIG. 2 is a flow diagram showing the target advertising method using the e-mail based on the preference of the customer, according to the present invention.

In this method, an advertising target is first selected at step s220. An advertising client (or an agent therefor) uses such a menu for selecting a target as provided by Ableclick™, or designates a query by using the database prepared on the basis of the result of having analyzed information on customer preferences.

The advertising client can select an exact target by repeating step 220 continuously until the advertising client is satisfied with the selected target and pushes a button for completing the selection step.

A target advertisement is then performed at step s240. The advertising client can request Ableclick™ to distribute any advertisement to the advertising target as selected.

When a netizen included in the advertising target opens the e-mail advertisement, the advertising server is informed of such an opening performance.

A result of performing the target advertisement is analyzed at step s260. The target advertising performance is analyzed by the advertising server, and on the basis of such analyzing result, an analysis report, including a table, a graph, etc., is automatically produced.

A target advertisement report is then presented at step s280. The on-line report prepared through the Ableclick™ web site is presented to the advertising client, and the advertising client can receive the report by logging onto the web site.

In summary, the advertising target is selected, an advertising client or an advertising agent uses a menu for selecting a target as provided by Ableclick™, or designates a query by using the database prepared on the basis of the result of having analyzed information on customer preferences. An advertising client requests Ableclick™ to distribute any advertisement to the advertising target as selected according to the present invention. When a netizen included in the advertising target opens said e-mail advertisement distributed by Ableclick™, the advertising server gets is informed of such opening performance. A result of performing said target advertisement is analyzed by the advertising server, and on the basis of such analyzing result, an analysis report, including a table, a graph, etc., is automatically produced. The target advertisement report is presented to the advertising client by logging onto the web site.

As described above, the present invention links conventional advertising target selections to a target advertisement, and also shortens a target selection period noticeably by improving the target selection work.

And according to the present invention, e-mail questionnaires are sent to customers and answers thereto are collected from customers, and thereby a propensity of customers and an advertising effect on customers can be determined, and further an e-mail target advertisement can be performed by using the determined result of the propensity and advertising effect.

The present invention may be modified and embodied in various forms, and it has been described and illustrated herein with reference to a specific embodiment thereof. However, it should be understood that this invention is not limited to the particular form as described above, and that this invention includes all modifications, equivalents and substitutes within the spirit and scope of this invention as defined in the “Claims” attached hereto.

What is claimed is:

1. A method for acquiring information on customer preferences on-line, comprising;
registering a customer with an Internet-based advertising agency as a member thereof;
collecting a profile of said member;
collecting a preference of said member on the basis of the collected profile of said member;
collecting an advertising effect on each member on the basis of said collected preference;
analyzing at least one of said collected profile, collected preference and collected advertising effect; and
preparing a report on the basis of the result of said analysis step and presenting said report to an advertising client member of the advertising agency.

2. A method as set forth in claim 1, wherein an Internet user registers with said advertising agency as a member through a web site of the agency.

3. A method as set forth in claim 2, wherein said member comprises one of a netizen member, a host member and an advertising client member.

4. A method as set forth in claim 3, wherein the profile of said member includes an e-mail address and a password, and other information required for paying a reserve fund and presenting a prize awarded by drawing from the reserve fund, to the member and receiving an advertising fee.

5. A method as set forth in claim 1, further comprising a step of changing member information at the advertising agency web site by revising or adding additional items to the member's profile.

6. A method as set forth in claim 5, wherein the changed information on the profile of said member automatically updates a database of the advertising agency.

7. A method as set forth in claim 1, wherein the advertising agency sends an e-mail questionnaire to said member on the basis of said collected profile in order to acquire information on the preference of said member by industries, by products or by advertising clients.

8. A method as set forth in claim 7, wherein when said member answers said e-mail questionnaire, said answer being automatically recorded in a preference database of the advertising agency.

9. A method as set forth in claim 8, wherein a profile analysis report, a preference analysis report and an advertising effect analysis report are respectively prepared on the basis of the answers from said member.

10. A method as set forth in claim 9, wherein said analysis report includes at least one of a table, a graph, a list and a detailed description.

11. A method as set forth in claim 10, wherein the table items of the analysis report are constituted of the percentage and the number of customers to be analyzed, and wherein this information is used as basic data for the e-mail target advertisement.

12. A method as set forth in claim 1, wherein said report is presented to the advertising client by logging onto the advertising agency's web site.

13. An e-mail target advertising method based on preferences of on-line customers comprising;
selecting an advertising target customer on the basis of a profile and preference of each customer of an Internet-based advertising agency;
providing a target advertisement to said selected target customer;
analyzing the result of said target advertisement; and
preparing a report on the target advertisement on the basis of the result of said analysis and presenting the report to an advertising client.

14. A method as set forth in claim 13, wherein an advertising client or an advertising agent uses a menu for selecting a target, as provided by the advertising agency.

15. A method as set forth in claim 13, wherein an advertising client or an advertising agent designates a query by using a database prepared on the basis of the analysis result of customer preferences when said advertising target is selected.

16. A method as set forth in claim 13, wherein an advertising client requests the advertising agency to distribute any advertisement to said advertising target as selected.

17. A method as set forth in claim 16, wherein when an advertising target customer opens an e-mail advertisement distributed the advertising agency, an advertising server is informed of such an opening.

18. A method as set forth in claim 13, wherein said target advertisement report is presented to the advertising client by logging onto the advertising agency web site.
